(19) United States
(12) Patent Application Publication
(10) Pub. No.: US 2018/0044602 A1
(43) Pub. Date: Feb. 15, 2018

(54) MINERAL FUNCTIONAL WATER, METHOD OF PRODUCING THE SAME, AND METHOD OF COMBUSTION-PROMOTING HYDROCARBONS

(71) Applicants: Riken Techno System Co., Ltd., Fukuoka (JP); Santa Mineral Co., Ltd., Tokyo (JP)

(72) Inventor: Koichi FURUSAKI, Fukuoka (JP)

(21) Appl. No.: 15/705,899

(22) Filed: Sep. 15, 2017

Related U.S. Application Data
(63) Continuation of application No. PCT/JP2016/058141, filed on Mar. 15, 2016.

(30) Foreign Application Priority Data
Mar. 16, 2015 (JP) 2015-052498

(51) Int. Cl. C10L 1/32; C02F 1/30; C02F 1/36; C02F 1/68; C02F 1/48

(52) U.S. Cl. CPC C10L 1/322; C02F 1/68; C02F 1/48; C02F 1/36; C02F 1/30; C10L 2200/0254; C10L 2200/0295

(57) ABSTRACT

Provided is mineral functional water including beneficial efficacy, such as improving action of combustion efficiency. Electromagnetic waves irradiated by mineral components contained in the mineral functional water according to the present invention reveals combustion-promoting action on hydrocarbons, such as hydrocarbons fuel.

### CROSS-REFERENCE TO RELATED APPLICATIONS

The present application is a continuation application of International Patent Application No. PCT/JP2016/058141 filed on Mar. 15, 2016, which claims priority to Japanese Patent Application No. 2015-052498 filed on Mar. 16, 2015, the entire contents of which are incorporated by reference.

### BACKGROUND OF THE INVENTION

### 1. Field of the Invention

The present invention relates to mineral functional water including beneficial effects, such as combustion-promoting action on hydrocarbons.

It is supposed that mineral-containing water may show effects including: soil-modifying action; plant-growing action; harmful organic substance-decomposing action; deodorizing action; and air-cleaning action. Conventionally, various kinds of mineral-containing water and equipment for producing mineral-containing water have been developed.

The present inventors have developed a mineral-containing water-producing apparatus (A) including:
a unit for immersing a conductive wire covered with insulator and mineral-imparting material (A) in water, conducting DC electric current to the conductive wire to generate water flow around the conductive wire in the same direction as the DC electric current, applying ultrasonic vibration to the water, thereby forming raw mineral water solution (A); and
a far-infrared ray-generating unit irradiating far-infrared rays to the formed raw mineral water solution (A) to produce mineral-containing water (A) (See, Reference 1.).

The present inventors also have developed mineral functional water-producing equipment including:
a mineral-containing water-producing apparatus (A);
a plurality of water-passing containers into which different kinds of mineral-imparting material (B) from each other is filled up;
a water supply passage communicating with the plurality of water-passing containers in series;
a roundabout channel connected to the water supply passage in a state where the roundabout channel is parallel to the plurality of water-passing containers, respectively; and
a water stream-changing valve provided in branch parts between the water supply passage and the roundabout channel, respectively (See, Reference 2.).

The present inventors have also reported that upon using the mineral functional water-producing equipment, mineral functional water (far-infrared ray-generating water) with functions of generating far-infrared rays of specific wavelength can be produced.

The present inventors have repeatedly studied kinds and mixing ratios of mineral-imparting material while using the mineral functional water-producing apparatus disclosed in Reference 2, and have reported that mineral functional water produced under a specific condition shows excellent controlling effects upon unicellular organisms and/or viruses (See, Reference 3.).

Up to now a phenomenon has been known, the phenomenon being that action exciting combustion can be performed upon exciting fuel containing hydrocarbons. For example, when applying an electric field on the combustion, it is observed that flame forms change and burning velocity also changes.

However, the fuel containing hydrocarbons temporarily excited by electromagnetic waves shortly returns to the ground state thereof. Accordingly, it is difficult to obtain effects that the combustion is stably improved.

In view of such a problem, the apparatus disclosed in Reference 4 is configured by:

utilizing a waveguide as a flow path for hydrogen compounds (hydrocarbon fuel);

irradiating high-frequency electromagnetic waves within the flow path by a magnetron; and

constituting a plurality of strong magnetic fields along in a flow direction of the hydrogen compounds (hydrocarbon fuel), the flow direction being orthogonal to the propagation direction of the electromagnetic waves to be along induced lines of magnetic force.

This structure enables to repeat electron paramagnetic resonance so as to keep the hydrogen compounds (hydrocarbon fuel), thereby improving combustion efficiency.

### REFERENCES

Reference 1: Japan registered patent No. 4817817.
Reference 2: Japanese patent application Laid-open No. 2011-56366
Reference 3: Japanese registered patent No. 5864010.
Reference 4: Japanese registered patent No. 3210975

### OBJECTS AND SUMMARY OF THE INVENTION

As mentioned above, various kinds of mineral-containing water have been reported in the past. Many of effects showed by mineral-containing water have not been scientifically proven, and true action of the mineral-containing water also has been not yet made clear in some respects.

In many cases, conventional mineral-containing water may not actually show advertised effects, may merely show effects which are insufficient for practical use, or, may has poor reproducibility of the effects.

With respect to even the mineral functional water produced using the device reported in References 1 and 2, it cannot be said that the target of the mineral functional water manifesting enough effects can surely be produced.

In particular, kinds and mixing ratios of material components (mineral-imparting material) used in the mineral-containing water-producing apparatuses (A) and (B) intricately concern. In fact, relationships between a kind of used mineral-imparting material and effects showed by obtained mineral functional water are not always proven.

Combustion-promoting action caused by mineral functional water has been hardly considered.

The technique disclosed in Reference 1, because of maintaining the excited state of the fuel of hydrocarbons so as to improve the combustion efficiency, requires a device for keeping irradiating the electromagnetic waves according to a predetermined method. This must be a serious kind of limitation.

In view of the above, an object according to the present invention is to provide mineral functional water revealing beneficial effects, such as combustion-promoting action on hydrocarbons.

Using the mineral functional water-producing equipment disclosed in Reference 2, the present inventors have repeated consideration mainly focusing on the kinds and the mixing ratios of mineral-imparting material.

Finally, the present inventors have found out that the mineral functional water produced under a certain specific condition manifests useful combustion-promoting action on hydrocarbons, thereby having devised the present invention.

That is, the present invention concerns the following inventions.
Item [1]: Mineral functional water, including mineral components of electromagnetic radioactivity and showing activating action on hydrocarbons.
Item [2]: The mineral functional water as defined in Item 1, further showing combustion-promoting action on hydrocarbons.
Item [3]: The mineral functional water as defined in Item 1, wherein the mineral components irradiate electromagnetic waves including wavelength resonating with mutual stretching vibration between C—H of molecules existing in the hydrocarbons.
Item [4]: Composition containing the mineral functional water as defined in any one of Items 1 to 4.
Item [5]: A method of producing mineral functional water, comprising:
producing first mineral-containing water (A) according to the following first process (1): and
producing second mineral-containing water (B) according to the following second process (2):
the mineral functional water containing the first produced mineral-containing water (A) and the second produced mineral-containing water (B) according to a ratio within a range of 1:5-1:20 (weight ratio),
wherein the first process (1) includes:
immersing a conductive wire covered with insulator and mineral-imparting material (A) into water, the mineral-imparting material containing: woody plant raw material; vegetation raw material; and activated carbon, the vegetation raw material including: vegetation belonging to Asteraceae and vegetation belonging to Rosaceae, the woody plant raw material including at least one kind selected from a group consisting of Maple, Betula platyphylla, Pinus, and Cryptomeria japonica;
conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A), and
wherein the second process (2) uses six connected in series water-passing containers in which different kinds of inorganic mineral-imparting material (B) from each other is filled, the six water-passing containers including: a first water-passing container; a second water-passing container; a third water-passing container, a fourth water-passing container; a fifth water-passing container; and a sixth water-passing container,
wherein:
the mineral-imparting material (B1) filled into the first water-passing container is mixture including: 70 weight % of lime stone; 15 weight % of fossil coral; and 15 weight % of shell, respectively;
the mineral-imparting material (B2) filled into the second water-passing container is mixture including: 40 weight % of lime stone; 15 weight % of fossil coral; 40 weight % of shell; and 5 weight % of activated carbon, respectively;
the mineral-imparting material (B3) filled into the third water-passing container is mixture including: 80 weight % of lime stone; 15 weight % of fossil coral; and 5 weight % of shell, respectively;
the mineral-imparting material (B4) filled into the fourth water-passing container is mixture including: 90 weight % of lime stone; 5 weight % of fossil coral; and 5 weight % of shell, respectively;
the mineral-imparting material (B5) filled into the fifth water-passing container is mixture including: 80 weight % of lime stone; 10 weight % of fossil coral; and 10 weight % of shell, respectively; and
the mineral-imparting material (B6) filled into the sixth water-passing container is mixture including: 60 weight % of lime stone; 30 weight % of fossil coral; and 10 weight % of shell, respectively, and
making the water pass through the six water-passing containers to form mineral-containing water (B).
Item [6]: The method of producing mineral functional water as defined in Item 5, wherein:
10 to 15 weight % of the mineral-imparting material (A) based on the water is added; and the DC electric current conducted to the conductive wire has 0.05-0.1 A of a current value and 8000-8600 V of a voltage value, respectively.
Item [7]: The method of producing mineral functional water as defined in any of Items 5 to 6, wherein:
dried pulverized product of Asteraceae plants and dried pulverized product of Rosaceae plants are used as the mineral-imparting material (A);
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof) to produce third mixture; making the third mixture dry; and then pulverizing the dried third mixture; and
the activated carbon is composed of activated carbon powder (A3) produced by carbonizing coconut shell at activation temperature of 1000 Centigrade; and
the mineral-imparting material (A′) is obtained by;
mixing the vegetation raw material (A1) and the woody plant raw material (A2) according to 1:3 (weight ratio) to produce plant mixture; and
based on 100 pts. wt. of the plant mixture, mixing 2-8 weight % of the activated carbon powder (A3) thereto.
Item [8]: A method of combustion-promoting hydrocarbons, comprising:
directly or indirectly applying at least one of the mineral functional water as defined in any one of Items 1 to 3 and the composition as defined in Item 5 onto fuel containing hydrocarbons.

Preferable Embodiments of the mineral functional water according to the present invention concern the first invention [X1] and the second invention [X2], each of which is a producing method as specified below.

The mineral functional water according to the second invention [X2] corresponds to mineral functional water in Example 1 mentioned later.
[X1]: Mineral functional water produced by a method comprising:
producing first mineral-containing water (A) according to the following first process (1): and
producing second mineral-containing water (B) according to the following second process (2):
the mineral functional water containing the first produced mineral-containing water (A) and the second produced mineral-containing water (B) according to a ratio within a range of 1:5-1:20 (weight ratio),
wherein the first process (1) includes:
immersing a conductive wire covered with insulator and mineral-imparting material (A) into water, the mineral-imparting material containing: woody plant raw material; and vegetation raw material; the vegetation raw material including: vegetation belonging to Asteraceae and vegetation belonging to Rosaceae, the woody plant raw material including at least one kind selected from a group consisting of Maple, Betula platyphylla, Pinus, and Cryptomeria japonica;
conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A), and
wherein 10 to 15 weight % of the mineral-imparting material (A) based on the water is added; and the DC electric current conducted to the conductive wire has 0.05-0.1 A of a current value and 8000-8600 V of a voltage value, respectively,
wherein:
dried pulverized product of Asteraceae plants and dried pulverized product of Rosaceae plants are used as the mineral-imparting material (A);
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof) to produce third mixture; making the third mixture dry; and then pulverizing the dried third mixture; and
activated carbon is composed of activated carbon powder (A3) produced by carbonizing coconut shell at activation temperature of 1000 Centigrade; and
the mineral-imparting material (A′) is obtained by;
mixing the vegetation raw material (A1) and the woody plant raw material (A2) according to 1:3 (weight ratio) to produce plant mixture; and
based on 100 pts. wt. of the plant mixture, mixing 2-8 weight % of the activated carbon powder (A3) thereto,
wherein the second process (2) uses six connected in series water-passing containers in which different kinds of inorganic mineral-imparting material (B) from each other is filled, the six water-passing containers including: a first water-passing container; a second water-passing container; a third water-passing container; a fourth water-passing container; a fifth water-passing container; and a sixth water-passing container,
wherein:
the mineral-imparting material (B1) filled into the first water-passing container is mixture including: 70 weight % of lime stone; 15 weight % of fossil coral; and 15 weight % of shell, respectively;
the mineral-imparting material (B2) filled into the second water-passing container is mixture including: 40 weight % of lime stone; 15 weight % of fossil coral; 40 weight % of shell; and 5 weight % of activated carbon, respectively;
the mineral-imparting material (B3) filled into the third water-passing container is mixture including: 80 weight % of lime stone; 15 weight % of fossil coral; and 5 weight % of shell, respectively;
the mineral-imparting material (B4) filled into the fourth water-passing container is mixture including: 90 weight % of lime stone; 5 weight % of fossil coral; and 5 weight % of shell, respectively;
the mineral-imparting material (B5) filled into the fifth water-passing container is mixture including: 80 weight % of lime stone; 10 weight % of fossil coral; and 10 weight % of shell, respectively; and
the mineral-imparting material (B6) filled into the sixth water-passing container is mixture including: 60 weight % of lime stone; 30 weight % of fossil coral; and 10 weight % of shell, respectively, and
making the water pass through the six water-passing containers to form mineral-containing water (B).
[X2]: The mineral functional water as defined in Item X1, wherein the first produced mineral-containing water (A) and the second produced mineral-containing water (B) are mixed according to a ratio within a range of 1:10 (weight ratio).

### EFFECT OF INVENTION

The present invention provides mineral functional water including beneficial effects, such as combustion-promoting action on hydrocarbons.

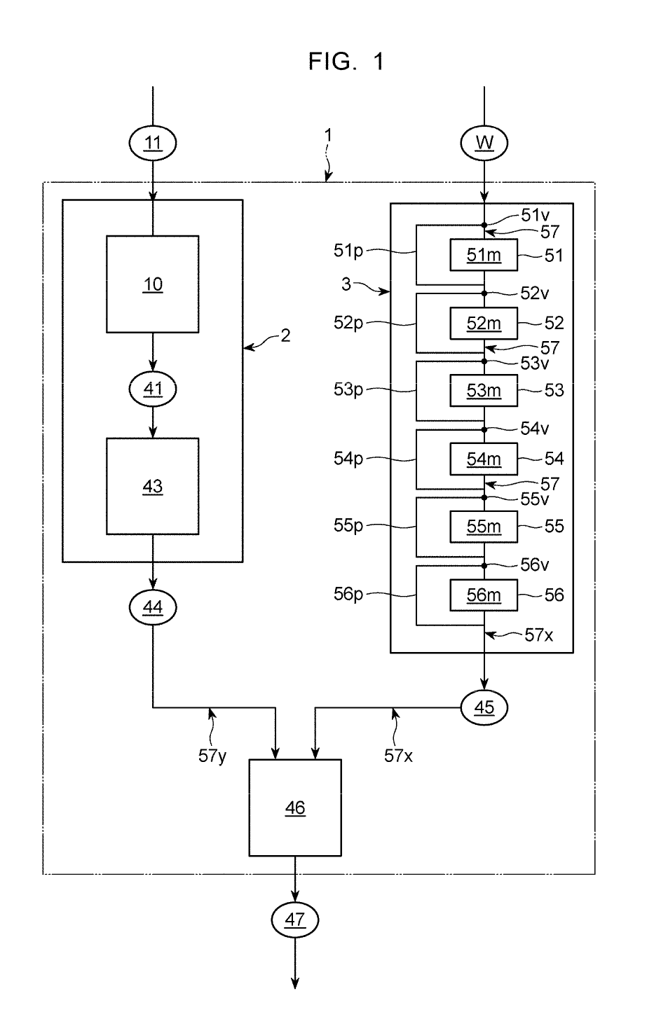

FIG. 1 is a block diagram showing a schematic structure of mineral functional water-producing equipment;

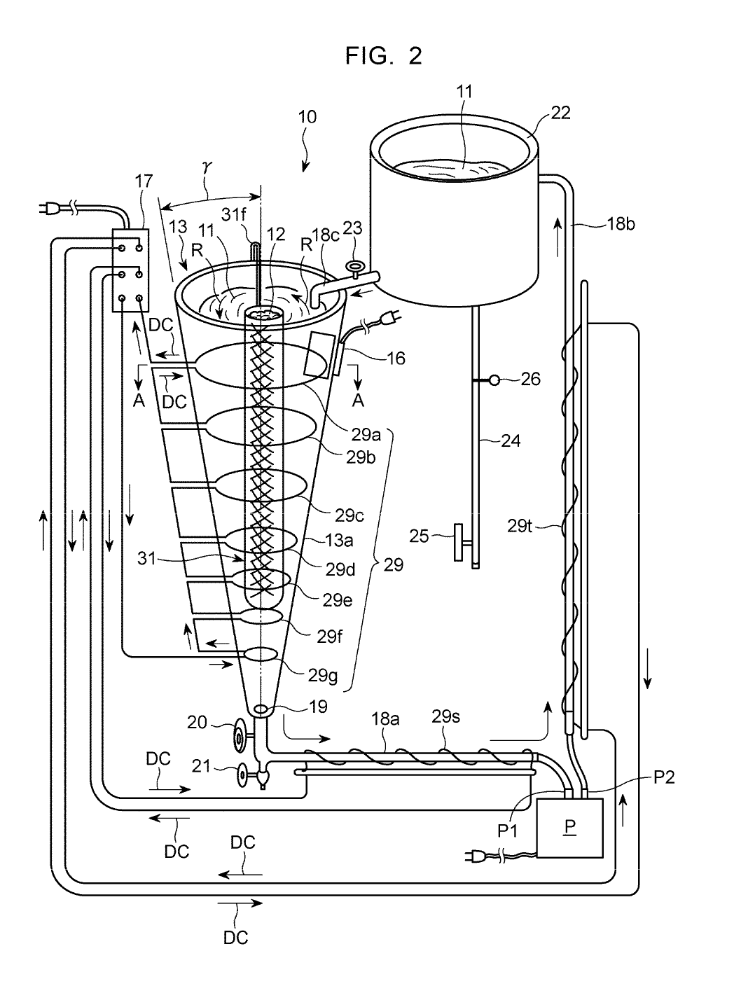

FIG. 2 is a mimetic diagram of a mineral-containing water solution production unit configuring a part of mineral-containing water (A) producing apparatus that constitutes the mineral functional water-producing equipment shown in FIG. 1;

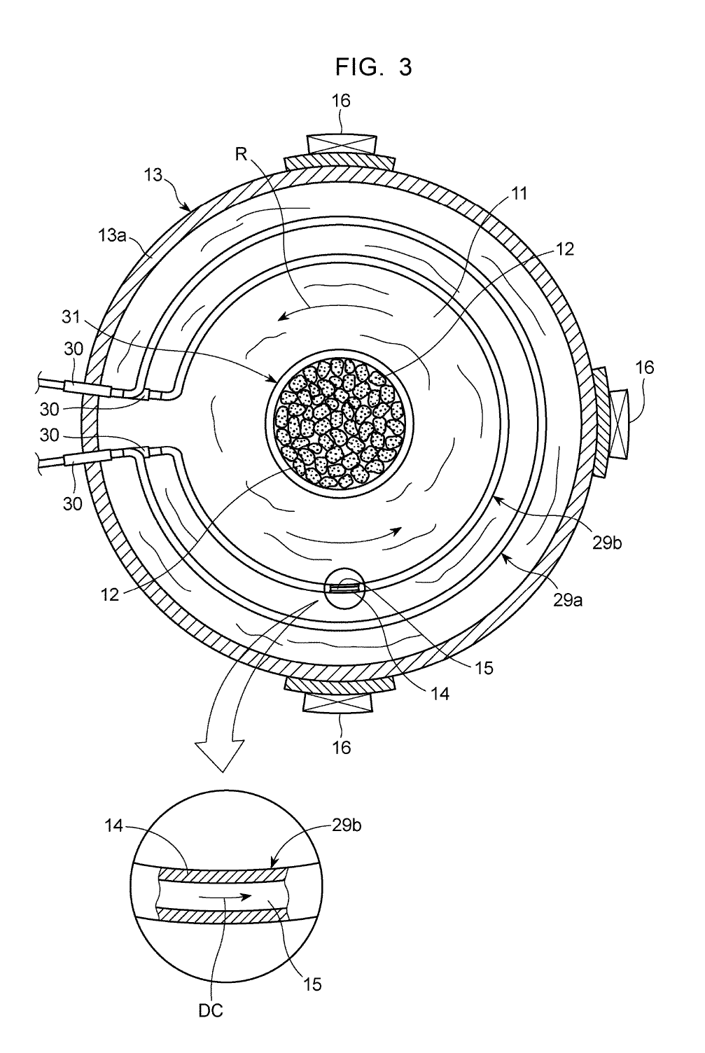

FIG. 3 is a partial sectional view of FIG. 2 according to the A-A line thereof;

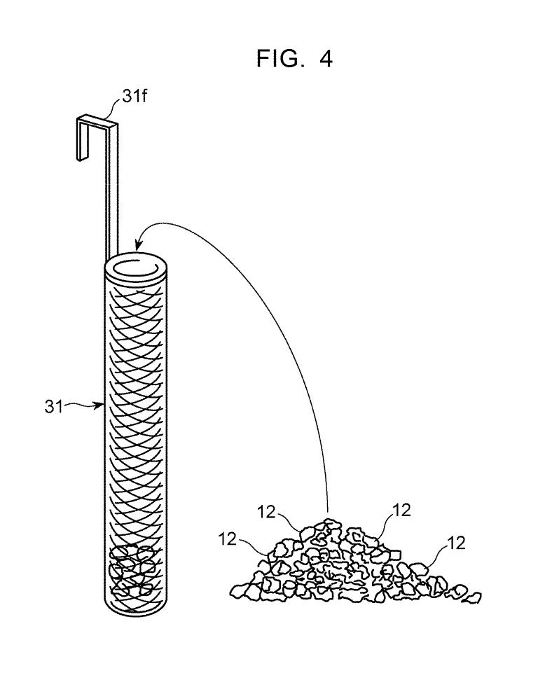

FIG. 4 is a perspective view of a housing container of the mineral-imparting material (A) used for the raw mineral water solution production unit shown in FIG. 2;

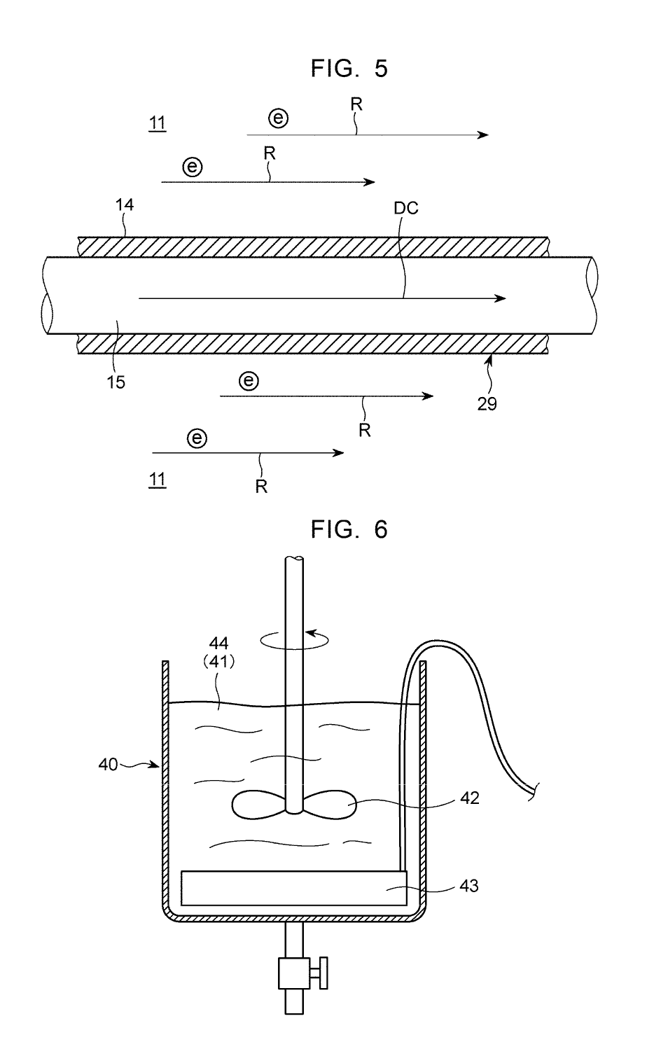

FIG. 5 is a mimetic diagram showing a reaction state near a conductive wire in the raw mineral water solution production unit shown in FIG. 2;

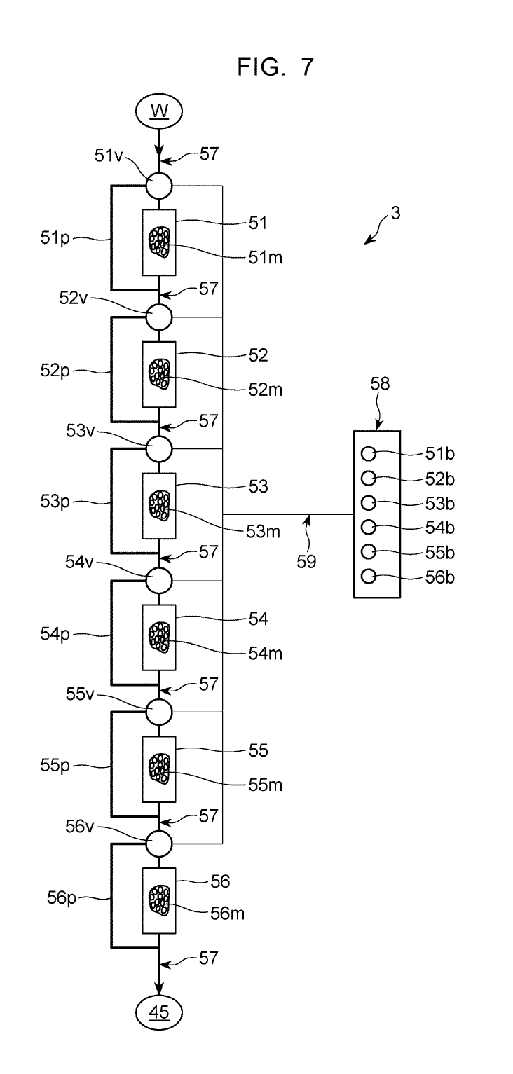

FIG. 6 is a sectional view of far-infrared ray-irradiating apparatus configuring a part of the mineral-containing water (A) producing apparatus that constitutes the mineral functional water-producing equipment shown in FIG. 1;

FIG. 7 is a block diagram of mineral-containing water (B) producing apparatus that constitutes the mineral functional water-producing equipment shown in FIG. 1;

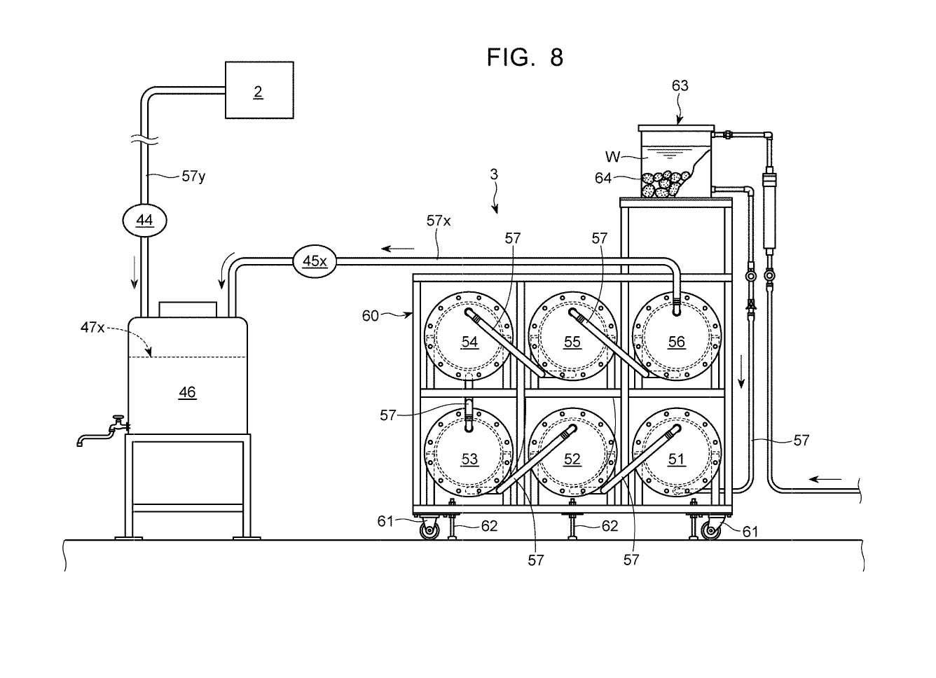

FIG. 8 is a front view showing the mineral-containing water (B) producing apparatus that constitutes the mineral functional water-producing equipment shown in FIG. 1:

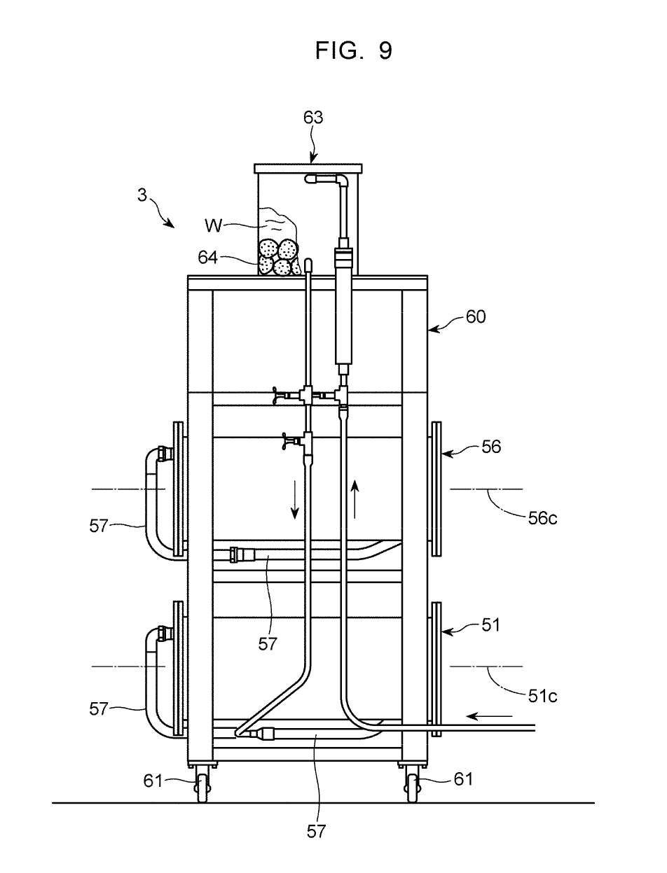

FIG. 9 is a side view of the mineral-containing water (B) producing apparatus shown in FIG. 8:

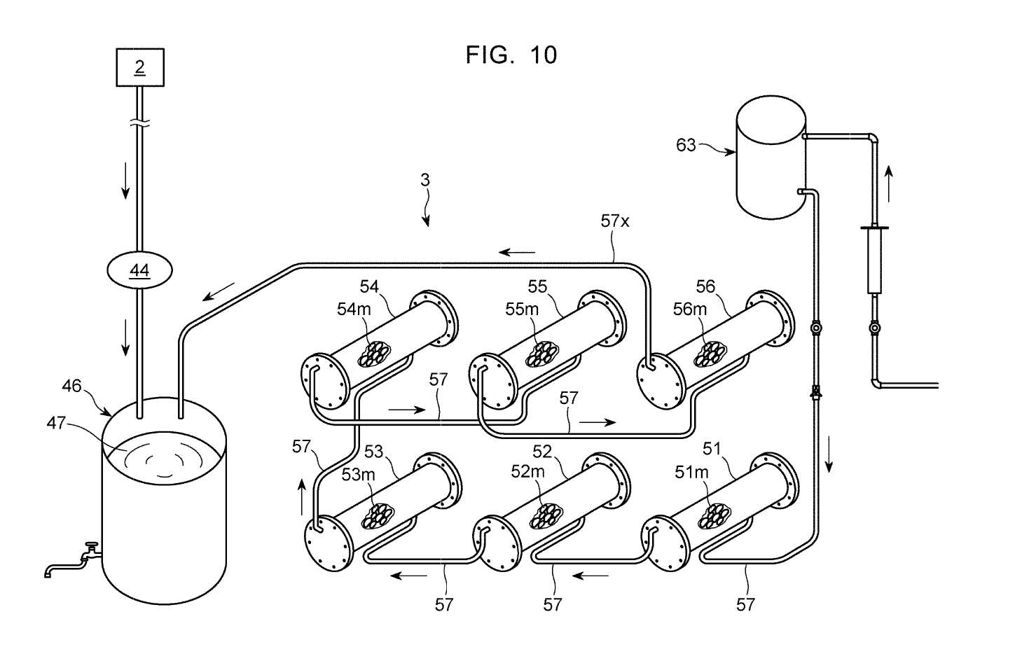

FIG. 10 is a partial perspective view showing the structure of the mineral-containing water (B) producing apparatus shown in FIG. 8:

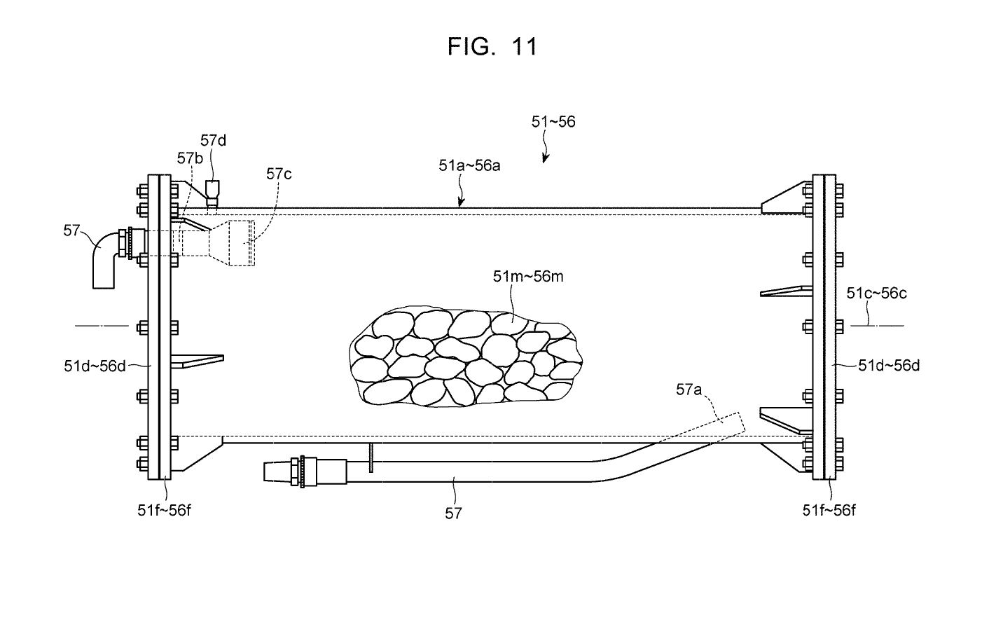

FIG. 11 is a side view of a water-passing container that constitutes the mineral-containing water (B) producing apparatus shown in FIG. 8;

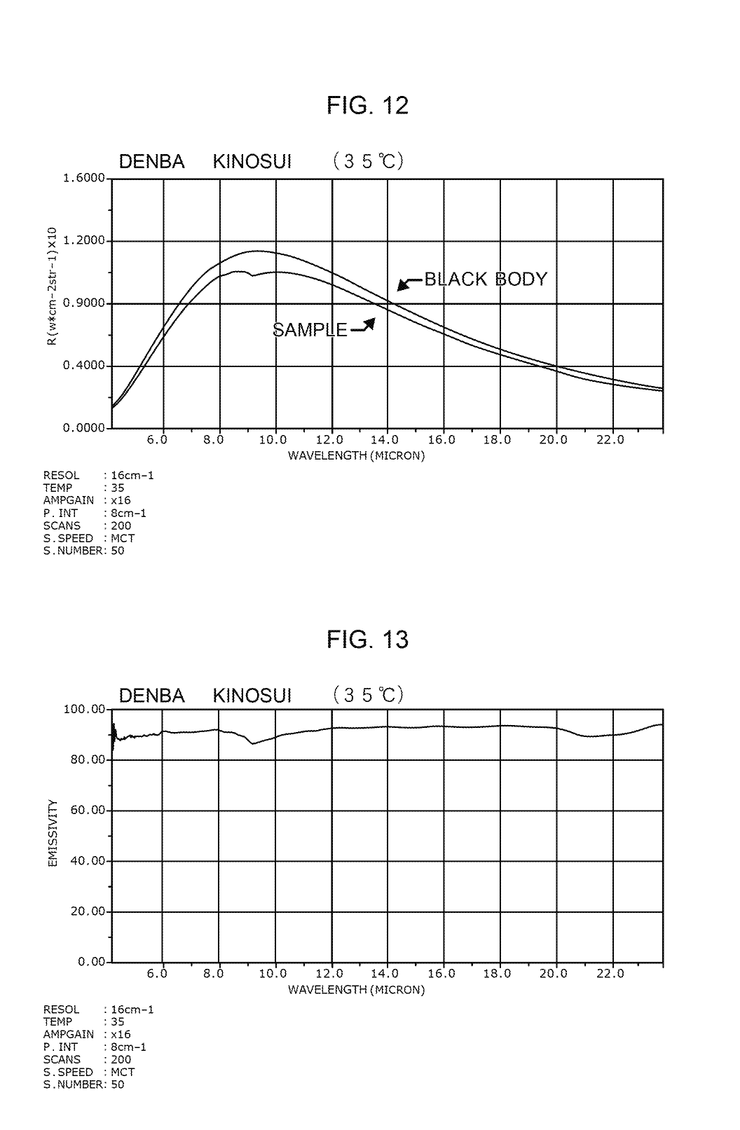

FIG. 12 shows spectral radiation spectra of the black body (theoretical values) and a sample in Example 1 wherein 20 pts. wt. of mineral functional water in Example 1 is fixed based on 100 pts. wt. of ceramic carriers (measurement temperature: 35 Centigrade, range of wavelength: 4-24 micrometers, ref. carrier: ceramic powder);

FIG. 13 shows emissivity (at 35 Centigrade) of the sample according to the present invention based on the black body; and

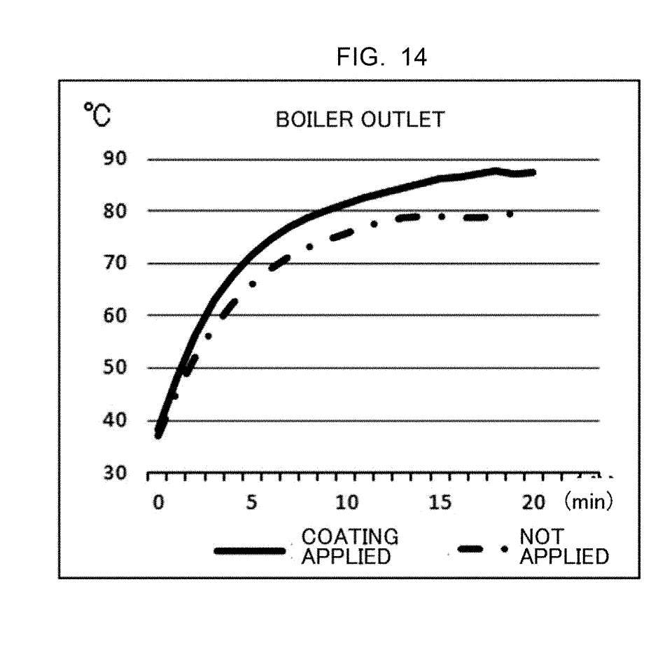

FIG. 14 shows results of measured temperature at an outlet of an agricultural boiler (before/after the mineral functional water in Example 1 has been applied thereto).

### BRIEF EXPLANATION OF SYMBOLS

1: mineral functional water-producing equipment
2: mineral-containing water (A) producing apparatus
3: mineral-containing water (B) producing apparatus
10: raw mineral water solution production unit
11, W: water
12: mineral-imparting material (A)
13: reaction vessel
13a: wall body
14: insulator
15: conductive wire
16: ultrasonic wave generation unit
17: DC power supply device
18a, 18b, 18c: circulating passage
19: drain port
20, 23: opening control valve
21, 25: drain valve
22: housing tank
24: drain pipe
26: water temperature gage
29, 29a-29g, 29s, 29t: conductive cable
30: terminal
31: housing container
31f: hook
40: treatment container
41: raw mineral water solution (A)
42: agitation blade
43: far-infrared ray-generating unit
44: mineral-containing water (A)
45: mineral-containing water (B)
46: mixing tank
47: mineral functional water
51: first water-passing container
52: second water-passing container
53: third water-passing container
54: fourth water-passing container
55: fifth water-passing container
56: sixth water-passing container
51a-56a: main body part
51b-56b: switching button
51c-56c: axial center
51d-56d: lid body
51f-56f: flange part
51m-56m: mineral-imparting material (B)
51p-56p: roundabout channel
51v-56v: water stream-changing valve
57, 57x, 57y: water-supply passage
57a: water inlet
57b: water outlet
57c: mesh strainer
57d: automatic air valve
58: operation panel
59: signal cable
60: support frame
61: caster
62: level adjuster
63: raw water tank
DC: direct electric current
DW: tap water
R: water flow

### DETAILED DESCRIPTION OF THE PREFERRED EMBODIMENTS

Hereinafter, with reference to the accompanying drawings, the present invention will now be explained while adducing some examples. The present invention, however, is not limited to the examples, and may be arbitrarily modified and/or changed within the scope of the present invention.

In addition, in this specification, the symbol of “-” is used for expression that means containing values and/or physical quantity below and over thereof.

In this specification, the words of “A and/or B” mean at least one of: either A or B; and both A and B. That is, the words of “A and/or B” includes: only A; only B; and both A and B.

### [1 Mineral Functional Water According to the Present Invention]

The mineral functional water according to the present invention is mineral functional water containing mineral components of electromagnetic radioactivity and showing activating action on hydrocarbons.

The raw material of the mineral functional water according to the present invention and a method for producing the same will be later explained in paragraphs related to [3 Method of producing mineral functional water according to the present invention].

Details will be mentioned later. The mineral functional water according to the present invention includes the combustion-promoting action on hydrocarbons as beneficial effects thereof.

The mineral functional water whose raw material differs from that of the present invention (for example, mineral functional water disclosed in Reference 3 (Japanese registered patent No. 5864010)) does not show significant combustion-promoting action on hydrocarbons.

In other words, the action is special to the mineral functional water according to the present invention.

In this specification, “mineral functional water” means water that contains at least one mineral component to reveal at least one or more kind(s) of beneficial effects.

Furthermore, in this specification, “mineral-containing water” means raw material water at a preceding stage when producing the mineral functional water, and also contains at least one mineral component.

Details thereof will be described regarding a method of producing the mineral functional water according to the present invention.

Note that the mineral-containing water itself may have the beneficial effects, or may not.

In this specification, the “mineral component” does not mean one of inorganic components, which include trace elements, defined in a narrow sense except the 4 Elements of carbon, hydrogen, nitrogen, and oxygen.

As long as co-existing with the inorganic components, the “mineral component” may contain at least one of the 4 Elements of carbon, hydrogen, nitrogen, and oxygen which are excluded in a narrow sense.

Therefore, for example, a “mineral component derived from plants” is a broad concept that includes not only at least one of inorganic components such as calcium derived from the plants but also at least one of organic components other than the above derived from the plants.

The inorganic component constituting the mineral component may be sodium, potassium, calcium, magnesium, phosphorus, or the like. And, the trace element may be iron, zinc, copper, manganese, iodine, selenium, chromium, molybdenum, or the like. However, neither the inorganic component nor the trace element is limited to these elements.

Hereinafter, the mineral functional water according to the present invention will now be explained in more detail.

The words of “activating action on hydrocarbons” mean action of exciting stretching vibration, oscillation, and/or rotation within molecules in hydrocarbons and/or bonding between the molecules, thereby activating the hydrocarbons.

In the present invention, the word of “hydrocarbons” is a general term including not only compounds consisting of carbon atoms and hydrogen atoms but also substances containing carbon atoms.

Hydrocarbons containing hetero-atoms such as oxygen atoms and nitrogen atoms, and substances complexly containing one or more of the above (e.g. plants (such as vegetation), products derived therefrom, charcoal, coal, oil, natural oil fat, synthetic fluid fat, or the like are also included therein.

Hydrocarbons may be of gas, liquid, solids, and mixture thereof.

Hydrocarbons may further contain plural kinds of hydrocarbons.

As the hydrocarbons, hydrocarbons especially usable for fuel (hereinafter, may be recited as “fuel hydrocarbons”) are preferable targets.

The activating action on hydrocarbons of the mineral functional water according to the present invention improves chemical reactivity of the hydrocarbons, thereby promoting combustion of the hydrocarbons.

Why the mineral functional water according to the present invention reveals the activating action on hydrocarbons and/or the action of promoting combustion of hydrocarbons is not clear in some aspects. It is considered that at least electromagnetic waves irradiated by mineral components may contribute thereto.

The mineral components contained in the mineral functional water according to the present invention irradiate electromagnetic waves including wavelength resonating with mutual stretching vibration between C—H of molecules existing in the hydrocarbons.

The wavelength resonating with mutual stretching vibration between C—H of molecules existing in the hydrocarbons is regarded as some dozens of micrometers (about 5 [THz]), and the mineral functional water according to the present invention irradiates the terahertz waves belonging to this region.

The mineral functional water according to the present invention can be specified with a finger printing method based on a form of spectral emissivity within a specific wavelength band (wavelength from 4 micrometers to 24 micrometers).

It is difficult to directly measure the spectral emissivity of a liquid sample. Therefore, measurement thereof is normally performed using a method of fixing the sample onto a reference carrier.

The spectral radiation spectrum of the mineral functional water according to the present invention is measured while having fixed the mineral functional water onto ceramic powder for carrying thereof.

More concretely, in a preferable embodiment (as shown in Examples) of the mineral functional water according to the present invention, a special form is shown in FIG. 12.

FIG. 12 shows spectral radiation spectra of the black body (theoretical values) and a sample in Example 1 wherein 20 pts. wt. of the mineral functional water is fixed based on 100 pts. wt. of ceramic carriers (measurement temperature: 35 Centigrade, range of wavelength: 4-24 micrometers).

Details of the measurement will be explained later in paragraphs related to Examples.

In this specification, “emissivity” is a ratio of the sample radiant emittance of a sample radiant surface to the base radiant emittance of the black body at the same temperature (JIS Z 8117), and “spectral emissivity” indicates percentage of the sample radiant emittance when the base radiant emittance of the black body is assumed to be 100%.

The evaluated sample has a specific spectral radiation spectrum.

The “black body” absorbs 100% of the entering light, and has the greatest energy radiation power. Theoretically, nothing can have energy radiation power more than the black body.

JIS R 180 has defined a measuring method of spectral radiation spectra. Measurement thereof can be made utilizing an emissivity-measuring system including equipment configuration in accordance with JIS R 180 using Fourier transform infrared spectroscopy (FTIR).

The far-infrared ray-radiating ratio-measuring apparatus (JIR-E500) produced by JEOL Ltd. can be adduced as a preferable example of the emissivity-measuring system.

The above-mentioned why the mineral functional water according to the present invention reveals the activating action on hydrocarbons and/or the action of promoting combustion of hydrocarbons is just estimation made according to the present knowledge.

Even if mechanism differing from the above will be discovered in the future, the beneficial effects of the mineral functional water according to the present invention should NEVER be restrictively interpreted.

The mineral functional water according to the present invention may display a plurality of useful effects differing from each other, and mechanisms thereof also may be different.

pH of the mineral functional water according to the present invention is 11-12.

pH of the mineral functional water according to the present invention is numerical expression of pH obtained by measuring the mineral functional water with a pH meter.

The mineral functional water according to the present invention may be diluted with preferable dilute solvents (water, alcohol, or the like) within a range wherein the object according to the present invention is not spoiled.

Optional components may be contained in the mineral functional water according to the present invention within a range wherein the effects thereof is not spoiled.

The optional components are not limited within the range wherein the object according to the present invention is not spoiled. Known suspension, emulsion, or the like may be used, for example.

A mixing ratio thereof is optional within the range wherein the object according to the present invention is not spoiled.

### [2 Usage of Mineral Functional Water]

The mineral functional water according to the present invention has one or more beneficial effects.

Hereinafter, the combustion-promoting action on the hydrocarbons, which is one of the beneficial effects according to the present invention, will now be explained.

In the present invention, the words of “combustion-promoting action” mean a concept including all of cases where the mineral functional water according to the present invention is directly or indirectly applied to a combustion engine and/or fuel, thereby improving combustion efficiency.

The electromagnetic waves irradiated by the mineral components contained within the mineral functional water according to the present invention have the activating action on hydrocarbons, thereby contributing to the combustion-promoting action.

That is, as long as the electromagnetic waves effectively are irradiated to fuel hydrocarbons, the mineral functional water according to the present invention may be directly applied to the fuel hydrocarbons fuel, or the mineral functional water may be indirectly applied to the fuel hydrocarbons fuel instead.

Herein, the words of “directly applying the water to the fuel hydrocarbons” mean a method of directly applying the mineral functional water to the fuel. More concretely, the method is suitably selected according to the form (gas, liquid, or solid) of fuel.

For example, in cases of liquid fuel and powder fuel, the mineral functional water according to the present invention may be mixed into the fuel. In another case of solid fuel such as pellets, the water may be coated thereon.

The words of “indirectly applying the water to the fuel hydrocarbons” mean that it is enough that the electromagnetic waves irradiated by the mineral components contained in the mineral functional water are also irradiated to the fuel. More concretely, in a case of a vehicle, the water may be coated on an engine, an engine room, or a combustion boiler so as to apply the electromagnetic waves to the inside thereof.

When it is difficult to directly apply the water to the object such as gas fuel and/or liquid fuel, the method of indirectly applying the water to the object is very effective.

For example, in a case where the water should be applied onto an engine, the water may be directly applied to the fuel itself. Alternatively as recited in Examples, the water may be applied to a radiator, or may be coated onto the engine and/or a boiler.

According to any of the above method, combustion efficiency and output performance are regarded to be improved.

The mineral functional water according to the present invention may be used as it is. More preferably, one or more other components may be added thereto to produce composition related thereto.

If the water should be directly applied to liquid fuel, the composition may include optional components such as known dispersing agents, stabilizer, and pH adjustor in order to be capable of mixing the water into the liquid fuel more easily.

The optional component should be suitably selected taking kinds, forms, and/or the like of fuel into consideration.

In a case where the water is coated onto an object such as an engine, a fuel boiler, or the like, additive agents used for coating compounds may be used, and/or composition produced by mixing the mineral functional water to known coating compounds may be also used.

Thus, the mineral functional water according to the present invention (or composition containing thereof for promoting combustion) acts directly or indirectly to the fuel hydrocarbons so as to promote the combustion fuel hydrocarbons.

For this reason, combustibility of fuel hydrocarbons and combustion efficiency are improved, thereby enabling to reduce exhaust of carbon dioxide and malignant gas.

The electromagnetic waves irradiated by the mineral components cause the combustion-promoting action of the mineral functional water according to the present invention. Accordingly, as long as the mineral components exist, the activating action on the fuel continues.

For this reason, without using any special devices irradiating electromagnetic waves, the activating action on the fuel is maintained for a long period of time. This is a remarkable benefit.

More concretely, coating the mineral functional water (or composition containing the same) onto a fuel-supplying system enables to act the electromagnetic waves to the fuel including hydrocarbons, thereby improving the combustor efficiency of the fuel. Coating the same onto devices within an engine room enables to raise performance of a battery and/or oil therein.

Furthermore, coating the same onto devices within an exhaust system enables to reduce carbon monoxide, hydrocarbon, and nitrogen oxide in exhaust gas.

How to apply the same is not limited in particular. In other words, one of known applying methods may be used. Fox example, a method of spraying the mineral functional water upon an object is adduced.

### [3. Method of Producing Mineral Function Water According to the Present Invention]

A method of producing the mineral functional water containing mineral components radiating electromagnetic waves (hereinafter, may be called as “the mineral functional water according to the present invention”) is not specially limited, which can be, utilizing the producing apparatus disclosed in Reference 2 (Japanese patent application Laid-open No. 2011-56366), produced according to a method based on the methods disclosed therein.

As long as capable of obtaining the mineral functional water containing mineral components radiating electromagnetic waves, a method of producing the same is not limited to the above method utilizing the producing apparatus, and another method may be used instead thereof.

Hereinafter, referring to the attached drawings, preferable Embodiment related to a method of producing mineral function water according to the present invention utilizing the apparatus disclosed in Reference 2 (Japanese patent application Laid-open No. 2011-56366) will now be explained.

As shown in FIG. 1, mineral functional water-producing equipment 1 includes: the mineral-containing water (A) producing apparatus 2; the mineral-containing water (B) producing apparatus 3; and the mixing tank 46 which is a mixing unit for mixing mineral-containing water (A) 44 produced by the mineral-containing water (A) producing apparatus 2 with mineral-containing water (B) 45 produced by the mineral-containing water (B) producing apparatus 3 to form mineral functional water 47.

The mineral-containing water (A) producing apparatus 2 includes: the raw mineral water solution production unit 10 using raw material of water 11 supplied from waterworks and mineral-imparting material (A) 12 mentioned later (See, FIG. 4.) to form raw mineral water solution (A) 41; and an far-infrared ray-generating unit 43 irradiating far-infrared rays to the raw mineral water solution (A) 41 obtained by the raw mineral water solution production unit 10 to change the raw mineral water solution (A) 41 into mineral-containing water (A) 44.

The mineral-containing water (B) producing apparatus 3 has a function of forming the mineral-containing water (B) 45 containing mineral components eluted from mineral-imparting material by making water W supplied from the outside pass through the water-passing containers 51-56.

Hereinafter, details of the mineral-containing water (A) producing apparatus 2 and the mineral-containing water (B) producing apparatus 3 will now be explained.

### (3-1: Mineral-Containing Water (A) Producing Apparatus)

Next, referring to FIG. 2-FIG. 6, the mineral-containing water (A) producing apparatus 2 constituting the mineral functional water-producing equipment 1 shown in FIG. 1 is explained.

As shown in FIG. 1, the mineral-containing water (A) producing apparatus 2 includes: the raw mineral water solution production unit 10 (See, FIG. 2) using raw material of water 11 supplied from waterworks and mineral-imparting material (A) 12 mentioned later (See, FIG. 4) to form raw mineral water solution (A) 41; and the far-infrared ray-generating unit 43 (See, FIG. 6) irradiating far-infrared rays to the mineral-containing water (A) solution 41 obtained by the raw mineral water solution production unit 10 to change the mineral-containing water (A) solution 41 into the mineral-containing water (A) 44.

As shown in FIG. 2 and FIG. 3, the raw mineral water solution production unit 10 includes: a reaction vessel 13 capable of storing the water 11 and the mineral-imparting material (A) 12 therein, the conductive wire 15 covered with the insulator 14 and immersed into the water 11 of the reaction vessel 13; the ultrasonic wave generation unit 16 applying ultrasonic vibration onto the water 11 in the reaction vessel 13; the DC power supply device 17 conducting DC electric current to the conductive wire 15; the circulating passages 18a and 18b which are means for generating the water flow R around the conductive wire 15 in the same direction as that of the DC electric current; and the circulation pump P.

Each of the DC power supply device 17, the ultrasonic wave generation unit 16, and the circulation pump P operates using electric supply from general commercial power.

The reaction vessel 13 is formed in a shape of an inverted conical whose upper surface is opened, and the drain port 19 is provided with a bottom thereof corresponding to the lower summit of the conical.

The circulating passage 18a communicating with the suction port P1 of the circulation pump P is connected to this drain port 19. The opening control valve 20 for adjusting volume of wastewater to the circulating passage 18a and the drain valve 21 for discharging the water or the like in the reaction vessel 13, are provided directly under the drain port 19.

A proximal end of the circulating passage 18b is connected to the discharge port P2 of circulation pump P, and a distal end of the circulating passage 18b is connected to the housing tank 22.

A proximal end of the circulating passage 18c for transporting the water 11 in the housing tank 22 into the reaction vessel 13 is connected near a bottom portion on the outer periphery of the housing tank 22, and a distal end of the circulating passage 18c is piped at a position facing an opening portion of the reaction vessel 13.

The opening control valve 23 for adjusting an amount of water transported into the reaction vessel 13 from the housing tank 22 is provided with the circulating passage 18c.

The drain pipe 24 including: the drain valve 25; and the water temperature gage 26, is connected to a bottom portion of the housing tank 22 in a suspended state.

If needed, upon opening the drain valve 25, the water in housing tank 22 can be discharged from a bottom end of the drain pipe 24, and at this time temperature of the water 11 passing through the drain pipe 24 can be measured with the water temperature gage 26.

As shown in FIG. 5, the plurality of conductive cables 29 (29a-29g) each of which includes: the conductive wire 15; and the insulator 14 covering the wire are wired so as to have shapes of rings located at positions having different depth from each other in the reaction vessel 13, respectively. All of the plurality of conductive cables 29a-29g and the reaction vessel 13 are coaxially arranged.

According to inside diameters of the reaction vessel 13 in the shape of the inverted conical, inside diameters of the plurality of conductive cables 29a-29g are gradually contracted so as to be a diameter corresponding to the respective arranged position thereof.

Each of the plurality of conductive cables 29a-29g is detachably connected to the insulating terminal 30 provided with the wall body 13a of the reaction vessel 13, if needed, a circular portion of the cables may be detached from the terminal 30, or may be attached thereto.

The cylindrical housing container 31 having a bottom portion and being formed with an insulating reticulum, is arranged at a portion corresponding an axial center of the reaction vessel 13. And, the mineral-imparting material (A) 12 is filled up within the housing container 31.

This housing container 31 is, by the hook 31f provided with an upper portion thereof, detachably engaged with an upper edge portion of the wall body 13a of the reaction vessel 13.

As shown in FIG. 2, the conductive cables 29s and 29t are spirally twisted around the periphery of the circulating passages 18a and 18b, respectively. DC electric current is supplied from the DC power supply device 17 to these conductive cables 29s and 29t.

A direction in which the DC electric current flows through the conductive cables 29s and 29t is set up so as to meet a direction in which the water flow runs within the circulating passages 18a and 18b.

In the raw mineral water solution production unit 10, a predetermined amount of water 11 is put into the reaction vessel 13 and the housing tank 22.

After having set the housing container 31, into which the mineral-imparting material (A) 12 has been filled up, to a center of the reaction vessel 13, the circulation pump P is activated, and the opening control valve 20 provided with the bottom portion of the reaction vessel 13 and the opening control valve 23 of the circulating passage 18c are adjusted.

Next, the water 11 from the reaction vessel 13 is made circulate so as to pass through the drain port 19, the circulating passage 18a, the circulation pump P, the circulating passage 18b, the housing tank 22, and the circulating passage 18c, thereby returning to the upper portion of the reaction vessel 13 again.

And then, upon activating the DC power supply device 17 and the ultrasonic wave generation unit 16, the elution reaction of the mineral components from the mineral-imparting material (A) 12 in the housing container 31 to the water 11 begins.

The working conditions when producing the raw mineral water solution (A) using the raw mineral water solution production unit 10 are not limited in particular. In this Embodiment, however, the raw mineral water solution (A) has been produced according to the following working conditions.

(1) The DC electric current DC having voltage of 8000-8600 V and current of 0.05-0.1 A has been conducted through the conductive cables 29, 29s, and 29t.

The insulator 14 constituting the conductive cable 29 or the like is made of polytetrafluoroethylene resin.

(2) The mineral-imparting material (A) 12 is filled up in the reaction vessel 13 with a mass ratio of 10 to 15% based on the water 11.

The mineral-imparting material (A) 12 will be explained later referring to concrete examples.

(3) It is sufficient that the water 11 merely contain electrolyte so that the DC electric current can work there-through.

For example, when containing about 10 g of sodium carbonates, which is a kind of electrolyte, based on 100 liters of the water, the water may be used as the water 11.

Alternatively, groundwater, as it is, can be used as the water 11.

(4) The ultrasonic wave generation unit 16 generates ultrasonic waves having a frequency of 30-100 kHz, and is arranged so that an ultrasonic vibration portion (not shown) thereof directly contact with the water 11 in the reaction vessel 13 to make the water 11 vibrate.

When the raw mineral water solution production unit 10 is activated on such conditions, in the reaction vessel 13, the water flow R rotating in a direction of a left-hand thread and being sucked into the drain port 19 occurs, the water 11 discharged from the drain port 19 passes through the circulating passages 18a and 18b or the like, and returns again into the reaction vessel 13. This state is continued.

Therefore, agitating action by the water flow R, action of the direct electric current flowing through the conductive cable 29, and ultrasonic vibration generated by the ultrasonic wave generation unit 16, make mineral components speedily elute from the raw mineral water solution (A) into the water 11, thereby enabling to produce with high efficiency the mineral-imparting material (A) 12 that necessary mineral components have been moderately dissolved therein.

In the raw mineral water solution production unit 10, the plurality of conductive cables 29a-29g, each of which is formed in the shape of the ring, are coaxially arranged within the reaction vessel 13. The water flow R rotating in the direction of the left-hand thread within the reaction vessel 13 is also generated.

Due to this, a comparatively dense field of electrical energy can be formed within the reaction vessel 13 of fixed volume. In other words, the raw mineral water solution (A) can be efficiently produced within the reaction vessel 13 having comparatively small capacity.

The reaction vessel 13 is formed in the shape of the inverted conical. Therefore, the water flow R flowing along with the plurality of conductive cables 29a-29g in the shapes of the rings can be generated comparatively easily and stably, thereby promoting elution of the mineral components.

The water flow R flowing in the inside of reaction vessel 13 shaped of the inverted conical increases flow velocity thereof as it goes toward the drain port 19 at the bottom portion of the reaction vessel 13. Therefore, contact frequency with the mineral-imparting material (A) 12 can also increase so as to catch more free electrons e existing in the water 11, thereby capable of increasing an amount of ionized minerals.

Furthermore, the housing tank 22 discharging and storing water 11 is provided between the circulating passages 18b and 18c. Therefore, while circulating the water 11 whose amount is greater than the volume of the reaction vessel 13, elution action of minerals can proceed.

For this reason, the raw mineral water solution (A) can be mass-produced with remarkably high efficiency.

When the circulation pump P is made continuously run to continue the above action, the raw mineral water solution (A) in which the mineral components have been eluted is produced as a result.

According to conditions including: the size of the drain port 19 at the bottom portion of the reaction vessel 13; the amount of circulating water; the shape (especially, the angle γ shown in FIG. 2 between the axial center C and the wall body 13a) of the reaction vessel 13; and so on, the appearance situation of free electrons e in the water 11 can be controlled. Action of the free electrons e upon the mineral-imparting material (A) 12 may change the water solubility of the mineral components.

When the raw mineral water solution (A) has been formed, this raw mineral water solution (A) 41 is moved into the treatment container 40 shown in FIG. 6.

At this stage, the residue of the mineral-imparting material (A) 12 leaked from the housing container 31 in the reaction vessel 13 can be discharged from the drain valve 21 at the bottom portion of the reaction vessel 13.

The far-infrared ray-generating unit 43 arranged within the treatment container 40 irradiates far-infrared rays to the raw mineral water solution (A) 41 stored in the treatment container 40 while the raw mineral water solution (A) is slowly agitated by the agitation blades 42.

It is sufficient for the far-infrared ray-generating unit 43 to generate far-infrared rays with wavelength of about 6-14 micrometers. The material and/or the generating unit thereof may be optional, and a heating method may be used for the same.

However, it is preferable that the unit has, at 25 Centigrade, emissivity of 85% or more to the radiation of the black body within a band of 6-14 micrometer wavelength.

In the raw mineral water solution production unit 10 shown in FIG. 2, according to: the agitation action by the water flow R; the action by the DC electric current conducting through the conductive wire 15; and the ultrasonic vibration, the mineral components contained in the mineral-imparting material (A) 12 speedily elutes into the water 11, thereby enabling to produce the mineral water solution 41 in which necessary mineral components have been moderately melt with high efficiency.

The far-infrared ray-generating unit 43 shown in FIG. 6 irradiates far-infrared rays to the mineral water solution 41 to amalgamate dissolved mineral components with water molecules, thereby producing the mineral-containing water (A) 44 whose electro-negativity is increased.

As shown in FIG. 1, the mineral-containing water (A) 44 formed according to the above-mentioned processes in the mineral-containing water (A) producing apparatus 2 is transported into the mixing tank 46 via the water supply passage 57y, and is mixed with the mineral-containing water (B) 45 transported from the mineral-containing water (B) producing apparatus 3 within the mixing tank 46.

Hereinafter, the mineral-imparting material (A) will now be explained.

The mineral-imparting material (A) contains: the vegetation raw material including at least one kind selected from a group consisting of vegetation belonging to Asteraceae, and vegetation belonging to Rosaceae; the woody plant raw material of woody plants including at least one kind selected form a group consisting of Maple, Betula platyphylla, Pinus, and Cryptomeria japonica; and activated carbon.

Vegetation other than Asteraceae and Rosaceae may be included. However, it is preferable that the only vegetation belonging to Asteraceae and Rosaceae is used.

As preferable Asteraceae vegetation, Farfugium japonicum, Artemisia indica, Cirsium japonicum, or the like are adduced.

As preferable Rosaceae vegetation, Rosa multiflora, Geum japonicum, Potentilla hebiichigo, Kerria japonica, Rubus L., or the like are adduced.

Used parts of the vegetation may be selected from a group from which mineral components are easily eluted, the group including leaf parts, stem parts, and flower parts. The uses parts may be used as they are. Dried product therefrom may used instead.

As the woody plant, Maple, Betula platyphylla, Pinus, and Cryptomeria japonica are adduced.

Used parts of the woody plant may be selected from a group from which mineral components are easily eluted, the group including leaf parts, stem parts, and flower pans. The uses pans may be used as they are. Dried product therefrom may used instead.

As preferable mineral-imparting material (A), the following material can be adduced, wherein:
dried pulverized product of Asteraceae plants and dried pulverized product of Rosaceae plants are used;
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof) to produce third mixture; making the third mixture dry; and then pulverizing the dried third mixture; and
the activated carbon is composed of activated carbon powder (A3) produced by carbonizing coconut shell at activation temperature of 1000 Centigrade; and
the mineral-imparting material (A′) is obtained by;
mixing the vegetation raw material (A1) and the woody plant raw material (A2) according to 1:3 (weight ratio) to produce plant mixture; and
based on 100 pts. wt. of the plant mixture, mixing 2-8 weight % of the activated carbon powder (A3) thereto.

What is adapted as activated carbon powder (A3) is prepared by:

under an inert gas atmosphere, carbonizing coconut shell at activation temperature of 1000 Centigrade to produce activated carbon powder; and

upon adding the activated carbon powder to pure water so as to have 10 weight %, adapting the powder-added water with pH of 9-11, preferably ph of 9.5-10.5, more preferably ph of 10.

Upon activating coconut shell at lower temperature, strong alkali tends to be produced. However as mentioned above, upon activating the coconut shell at 1000 Centigrade, weak alkali tends to be produced.

Regarding an amount of added activated carbon powder (A3), the activated carbon powder (A3) is added to the mineral-containing water (A) such that pH becomes 11-12 when the mineral-imparting material (A) and the mineral-containing water (B) are mixed with each other.

Further preparation is performed by;

mixing the vegetation raw material (A1) and the woody plant raw material (A2) according to 1:3 (weight ratio) to produce plant mixture; and

based on 100 pts. wt. of the plant mixture, mixing 2-8 weight % of the activated carbon powder (A3) thereto.

As such vegetation raw material (A1), “P-100 (lot number)” produced by Riken techno system Co., LTD., as such woody plant raw material (A2), “P-200 (lot number)” produced by Riken techno system Co., LTD., and as such activated carbon powder (A3), “AS-100 (lot number)” produced by Riken techno system Co., LTD. can be preferably used, respectively.

### (2-2: Mineral-Containing Water (B) Producing Apparatus)

Next, referring to FIG. 1 and FIG. 7, the structure and the functions of the mineral-containing water (B) producing apparatus 3, or the like will now be explained.

As shown in FIG. 1 and FIG. 7, the mineral-containing water (B) producing apparatus 3 includes: the first, the second, the third, the fourth, the fifth, and the sixth water-passing containers 51-56 into which a different kind of mineral-imparting material (B) from each other is filled up, respectively; the water supply passage 57 communicating the plurality of water-passing containers 51-56 in series; and the roundabout channels 51p-56p connected to the water supply passage 57 in a state where the roundabout channel is parallel to the plurality of water-passing containers 51-56, respectively; and the water stream-changing valves 51v-56v provided in branch parts from the water supply passage 57 and the roundabout channels 51p-56p, respectively.

The operation of switching the water stream-changing valves 51v-56v can be performed by operating the six switching buttons 51b-56b provided on the operation panel 58 connected to these water stream-changing valves 51v-56v via the signal cables 59.

The six switching buttons 51b-56b and the six water stream-changing valves 51v-56v correspond to each other according to the numbers thereof. Upon operating a certain one of the switching buttons 51b-56b, one of the water stream-changing valves 51v-56v having a number corresponding to the certain one is switched to change the direction of a water flow related thereto.

Within the first water-passing container 51, mineral-imparting material (B) 51m containing silicon dioxide and iron oxide is filled up.

Within the second water-passing container 52, mineral-imparting material (B) 52m containing silicon dioxide and activated carbon is filled up.

Within the third water-passing container 53, mineral-imparting material (B) 53m containing silicon dioxide and titanium nitride is filled up.

Within the fourth water-passing container 54, mineral-imparting material (B) 54m containing silicon dioxide and calcium carbonate is filled up.

Within the fifth water-passing container 55, mineral-imparting material (B) 55m containing silicon dioxide and magnesium carbonate is filled up.

Within the sixth water-passing container 56, mineral-imparting material (B) 56m containing silicon dioxide and calcium phosphate is filled up.

Here, the mineral-imparting material (B) 51m-56m can be preferably produced by mixing raw material based on a lime stone, fossil coral, and shell.

Firstly, components contained in the lime stone, the fossil coral, and the shell are analyzed, and the amounts of silicon dioxide, iron oxide, activated carbon, titanium nitride, calcium carbonate, magnesium carbonate, and calcium phosphate are evaluated, respectively.

Secondly, based on the respective content of the components, the lime stone, the fossil coral, and the shell are mixed to produce the mineral-imparting material (B) 51m-56m.

It is preferable that components contained in the mineral-imparting material (B) 51m-56m is controlled according to the mixing ratio of the lime stone, the fossil coral, and the shell. However, in some cases, the material of the lime stone, the fossil coral, and the shell has poor component(s) according to the source thereof. If so, at least one of silicon dioxide, iron oxide, activated carbon, titanium nitride, calcium carbonate, magnesium carbonate, and calcium phosphate may be added, if needed.

Especially, since the activated carbon is rarely contained in the lime stone, the fossil coral, and the shell, the activated carbon should usually be added separately.

When as the mineral-imparting material (B) 51m-56m, the mineral-imparting material (B1) filled into the first water-passing container 51 is mixture including: 70 weight % of lime stone; 15 weight % of fossil coral; and 15 weight % of shell, respectively; the mineral-imparting material (B2) filled into the second water-passing container 52 is mixture including: 40 weight % of lime stone; 15 weight % of fossil coral; 40 weight % of shell; and 5 weight % of activated carbon, respectively; the mineral-imparting material (B3) filled into the third water-passing container 53 is mixture including: 80 weight % of lime stone; 15 weight %/o of fossil coral; and 5 weight % of shell, respectively; the mineral-imparting material (B4) filled into the fourth water-passing container 54 is mixture including: 90 weight % of lime stone; 5 weight % of fossil coral; and 5 weight % of shell, respectively; the mineral-imparting material (B5) filled into the fifth water-passing container 55 is mixture including: 80 weight % of lime stone; 10 weight % of fossil coral; and 10 weight % of shell, respectively; and the mineral-imparting material (B6) filled into the sixth water-passing container 56 is mixture including: 60 weight % of lime stone; 30 weight % of fossil coral; and 10 weight % of shell, respectively, the mineral-containing water (B) that shows excellent controlling effects can be obtained upon being mixed with the mineral-containing water (A).

Especially, it is preferable that the lime stones, the fossil coral, and the shell that are used for the mineral-imparting material (B1)-(B6) satisfy the following Items (1-1) to (1-3).

### Item (1-1): Lime Stone

The lime stone is a small stone produced by crushing a rock of lime in which volcanic ore deposits containing the following components are mixed into a size of about 3 cm: calcium carbonate: 50 weight % or more;

iron oxide: 3 to 9 weight % of iron; and

sum total of titanium oxide, titanium carbide, titanium nitride: 0.8 weight % or more, and

magnesium carbonate: 7 to 10 weight %.

“CC-200 (lot number)” produced by Riken techno system Co., LTD. can be preferably used as such a lime stone.

### (1-2) Fossil Coral:

The fossil coral is granular material produced by mixing the following the two kinds of raw fossil coral according to a weight ratio of 1:9 to form mixture, and crushing the mixture into the size within 3-5 mm, the two kinds of raw fossil coral including: first fossil coral produced about 100 meters below the ground whose crystal construction has been denatured by pressure; and

second fossil coral produced from land near Amamiohshima Island, Okinawa-Ken, Japan, and including: calcium carbonate; calcium phosphate; and other trace elements. As such fossil coral, “CC-300 (lot number)” produced by Riken techno system Co., LTD. can be preferably used.

### (1-3) Shell:

The shell is granular material produced by mixing ear shell, abalone, and acorn shell of the same weight to form mixture, and crushing the mixture into the size within 3-5 mm.

“CC-400 (lot number)” produced by Riken techno system Co., LTD. can be preferably used as such shell.

### (1-4) Activated Carbon

The activated carbon may be made of optional material. However, preferably, activated carbon made of coconut shell can be adduced.

For example, “CC-500 (lot number)” produced by Riken techno system Co., LTD. whose raw material is coconut shell made in Thailand can be adduced.

Upon operating the switching buttons 51b-56b on the operation panel 58 mentioned above to switch the water stream-changing valves 51v-56v to the water-passing container side, water having passed through water supply passage 57 flows in into the first water-passing container 51 through the sixth water-passing container 56 located at the downstream of the operated water stream-changing valves. Alternatively, upon switching the water stream-changing valves 51v-56v to the roundabout channel side, the water having passed through water supply passage 57 flows into the roundabout channels 51p-56p located at the downstream of the operated water stream-changing valves.

Therefore, operating any of the switching buttons 51b-56b to selectively change the water stream-changing valves 51v-56v enables to produce the mineral-containing water (B) 45 into which mineral components selectively eluted from the mineral-imparting material (B) 51m-56m whose mineral components differ from each other according to the first water-passing container 51 through the sixth water-passing container 56.

Next, referring to FIG. 8 through FIG. 11, the practical structure and functions of the mineral-containing water (B) producing apparatus 3 will now be explained.

In FIG. 8 through FIG. 10, the roundabout channels 51p-56p, the water stream-changing valves 51v-56v, the operation panel 58, and the signal cables 59, which have been mentioned above, are omitted therefrom.

As shown in FIG. 8 and FIG. 9, the mineral-containing water (B) producing apparatus 3 includes: the first water-passing container 51 through the sixth water-passing container 56 each of which has a cylindrical shape and have been mounted on the support frame 60; and the water supply passage 57 communicating in series the first water-passing container 51 through the sixth water-passing container 56, wherein the raw water tank 63 for storing water W supplied from waterworks is arranged at the top part of the support frame 60.

In the raw water tank 63, the inorganic porous body 64 having a function of adsorbing impurities in the water W therein is stored.

The casters 61 and the level adjusters 62 are provided with the bottom portion of the support frame 60.

The first water-passing container 51 through the sixth water-passing container 56, each of which is cylindrically shaped, are mounted on the support frame 60 having a rectangular parallelepiped lattice structure in a state where each of axial centers 51c-56c (See, FIG. 9) of the containers are kept horizontally.

The first water-passing container 51 through the sixth water-passing container 56 has been detachably attached onto the support frame 60.

As shown in FIG. 10, the first water-passing container 51 through the sixth water-passing container 56 has the same structure, respectively. Each airtight structure thereof is formed by attaching the disk shaped lid bodies 51d-56d to the flange parts 51f-56f provided with the both ends of the main body parts 51a-56a in cylindrical shapes.

At the lowest portion of the main body parts 51a-56a when the axial centers 51c-56c are in horizontal states, the water inlet 57a communicating with the water supply passage 57 is provided. At the highest portion (far from the water inlet 57a) of the lid bodies 51d-56d, the water outlet 57b communicating with the water supply passage 57 is provided. And, the mesh strainer 57c is attached to the water outlet 57b.

The automatic air valves 57d for releasing air in the first water-passing container 51 through the sixth water-passing container 56 are attached onto the outer peripheries (the directly above portions of the water outlet 57b) of the main body parts 51a-56a.

The water supplied from the water supply passage 57 in the upstream passes through the water inlet 57a, flows into the first water-passing container 51 through the sixth water-passing container 56, and contacts with the mineral-imparting material (B) 51m-56m with which have been filled up therein, respectively. Therefore, the respective mineral components elute into the water to form water containing mineral components corresponding to the mineral-imparting material (B) 51m-56m, and the formed water flows from the water outlet 57b into the water supply passage 57 in the downstream.

In the mineral-containing water (B) producing apparatus 3 shown in FIG. 8-FIG. 10, operating any of the switching buttons 51b-56b on the operation panel 58 shown in FIG. 7 to make the water W in the raw water tank 63 pass through at least one of the first water-passing container 51 through the sixth water-passing container 56 enables to produce the mineral-containing water (B) 45 into which the special respective mineral components contained in the mineral-imparting material (B) 51m-56m filled up within the first water-passing container 51 through the sixth water-passing container 56 have been selectively dissolved therein.

Since the first water-passing container 51 through the sixth water-passing container 56 are connected in series with the water supply passage 57 in the mineral-containing water (B) producing apparatus 3, continuously making water flow into the water supply passage 57 enables to mass-produce the mineral-containing water (B) 45 that the mineral components corresponding to the mineral-imparting material (B) 51m-56m in the first water-passing container 51 through the sixth water-passing container 56 have been dissolved therein.

The mineral-containing water (B) 45 produced by the mineral-containing water (B) producing apparatus 3 is transported from the sixth water-passing container 56 via the water supply passage 57x in the downstream thereof into the mixing tank 46, and is therein mixed to the mineral-containing water (A) 44 produced by the mineral-containing water (A) producing apparatus 2 shown in FIG. 1, thereby forming the mineral functional water 47.

The mixing ratio of the mineral-containing water (A) and the mineral-containing water (B) is suitably determined considering: the kind of material included in the mineral-containing water (A) and the mineral-containing water (B); and the density of eluted components.

The weight ratio (the mineral-containing water (A):the mineral-containing water (B)) of the mineral-containing water (A) and the mineral-containing water (B) is: within a range of 1:5-1:20; preferably within a range of 1:7-1:12; and more preferably within a range of 1:10.

Both in a first case where the mineral-containing waters (A) is too little (the mineral-containing waters (B) is too much) and in a second case where the mineral-containing waters (A) is too much (the mineral-containing waters (B) is to little), there is a possibility that effective components contained in the mineral functional water are so much diluted that objective action is insufficiently showed.

In the above, the preferable Embodiment of the method of producing the mineral function water according to the present invention has been described. It is, however, sufficient that the mineral functional water according to the present invention including the above-mentioned configuration. Methods other than the above may be adopted instead thereof. In other words, it should be understood that the above description is not restrictive.

Especially, items that are not explicitly disclosed in the Embodiment, for example, operating conditions, running conditions, various parameters including a size of the elements, weight, volume, or the like do not deviate from a range where a person skilled in the art usually uses. Values capable of being easily assumed by the ordinary person skilled in the art are adopted.

### EXAMPLES

Hereinafter, the present invention will now be more concretely explained adducing the following Examples. Needless to say, the present invention is NEVER limited to the Examples.

### Example 1

### [1. Manufacturing Mineral Functional Water]

The mineral functional water producing apparatus in the Embodiment and the producing method mentioned above have been used. And then, as the mineral functional water, the mineral functional water in Example 1 has been produced utilizing the following material and the following method.

### 1. Manufacturing Mineral-Containing Water (A)

Raw material for producing the mineral-imparting material (A) for the mineral-containing water (A) includes the vegetation raw material (A1) and the woody plant raw material (A2) shown below.

As the vegetation raw material (A1), “P-100 (lot number)” produced by Riken techno system Co., LTD. have been used. As the woody plant raw material (A2), “P-200 (lot number)” produced by Riken techno system Co., LTD. has been used. As the activated carbon (A3), “AC-100 (lot number)” produced by Riken techno system Co., LTD. has been used.

“P-100” is the vegetation raw material (A1) produced by mixing the following dried pulverized product of Asteraceae plants and the following dried pulverized product of Rosaceae plants according to a weight ratio of 1:1, and “P-200” is the woody plant raw material (A2) described below.

### (A1) Vegetation Raw Material (Dried Vegetation Plants)

### (A1-1) Dried Pulverized Product of Asteraceae Plants

This has been produced by: mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof); respectively to produce first mixture thereof; making the first mixture dry; and then pulverizing the dried first mixture.

### (A1-2) Dried Pulverized Product of Rosaceae Plants

This has been produced by: mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof); respectively to produce second mixture thereof; making the second mixture dry; and then pulverizing the dried second mixture.

### (A2) Woody Plant Raw Material (Dried Woody Plants)

This has been produced by: mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof); respectively to produce third mixture thereof; making the third mixture dry; and then pulverizing the dried third mixture.

### (A3) Activated Carbon Powder Produced by Carbonizing Coconut Shell at Activation Temperature of 1000 Centigrade (Carbon: 85% or More; Remaining Components: Na, K, Si, or the Like; Particle Diameter: About 1 Micrometer)

Utilizing a pH meter, which is a glass electrode type hydrogen-ion density indicator “TPX-90” manufactured by Tohkoh Chemical Laboratories, pH has been measured to get a pH value of 10. The pH relates to preparation by: adding the activated carbon (A3) used in Examples to pure water to be mixed thereto so as to have 10 wt %.

The raw mineral water solution (A) has been produced by:

mixing the vegetation raw material (A1) and the woody plant raw material (A2) according to 1:3 (weight ratio) to produce plant mixture; and

based on 100 pts. wt. of the plant mixture, mixing 5 weight % of the activated carbon thereto so as to produce mineral-imparting material (A);

putting 10 to 15 weight % of the mineral-imparting material (A) based on the water into the raw mineral water solution production unit 10 (See, FIG. 2) of the mineral-containing water (A) producing apparatus 2 shown in FIG. 1;

conducting DC electric current having voltage of 8300 V and current of 100 mA has been conducted through the conductive wires of the raw mineral water solution production unit 10 to generate water flow around the conductive wires in the same direction as the DC electric current; and

applying ultrasonic vibration (oscillating frequency of 50 kHz, amplitude of 1.5/1000 mm) to the water, thereby producing the raw mineral water solution (A).

Next, far-infrared rays (wavelength: 6-14 micrometers) have been irradiated to the mineral water solution (A) 41 supplied to the latter far-infrared ray-generating unit 43 to obtain the mineral-containing water (A) in Example 1.

### 2. Manufacturing Mineral-Imparting Material (B)

The raw material for producing the mineral-imparting material (B) for the mineral-containing water (B), which has been produced by: mixing the lime stone, the fossil coral, the shell, and the activated carbon to produce fourth mixture thereof; and then pulverizing the fourth mixture, has been used.

Material of the mineral-imparting material (B) and the mixture (mineral-imparting material (B1)-(B6)) used for the first passing container through the sixth water-passing container will now be explained as follows.

### (1) Material

### (1-1) Lime Stone: “CC-200 (Lot Number)” Produced by Riken Techno System Co., LTD.

The lime stone is a small stone produced by crushing a rock of lime in which volcanic ore deposits containing the following components are mixed into a size of about 3 cm: calcium carbonate: 50 weight % or more; iron oxide: 3 to 9 weight % of iron; and sum total of titanium oxide, titanium carbide, titanium nitride: 0.8 weight % or more, and magnesium carbonate: 7 to 10 weight %.

### (1-2) “CC-300 (Lot Number)” Produced by Riken Techno System Co., LTD.

The fossil coral is granular material produced by mixing the following the two kinds of raw fossil coral according to a weight ratio of 1:9 to form mixture, and crushing the mixture into the size within 3-5 mm, the two kinds of raw fossil coral including: first fossil coral produced about 100 meters below the ground whose crystal construction has been denatured by pressure; and second fossil coral produced from land near Amamiohshima Island, Okinawa-Ken, Japan, and including: calcium carbonate; calcium phosphate; and other trace elements.

### (1-3) Shell: “CC-400 (Lot Number)” Produced by Riken Techno System Co., LTD.

The shell is granular material produced by mixing ear shell, abalone, and acorn shell of the same weight to form mixture, and crushing the mixture into the size within 3-5 mm.

### (1-4) Activated Carbon (Only Used for the Second Water-Passing Container): “CC-500 (Lot Number)” Produced by Riken Techno System Co., LTD.

### (2) Weight Ratios in the First Through the Sixth Water-Passing Containers

The first water-passing container:

The mineral-imparting material (B1) is mixture including: 70 weight % of lime stone; 15 weight % of fossil coral; and 15 weight % of shell.

The second water-passing container:

The mineral-imparting material (B2) is mixture including: 40 weight % of lime stone; 15 weight % of fossil coral; 40 weight % of shell; and 5 weight % of activated carbon, which corresponds to silicon dioxide and activated carbon.

The third water-passing container:

The mineral-imparting material (B3) is mixture including: 80 weight % of lime stone; 15 weight % of fossil coral; and 5 weight % of shell.

The fourth water-passing container:

The mineral-imparting material (B4) is mixture including: 90 weight % of lime stone; 5 weight % of fossil coral; and 5 weight % of shell.

The fifth water-passing container:

The mineral-imparting material (B5) is mixture including: 80 weight % of lime stone; 10 weight % of fossil coral; and 10 weight % of shell.

The sixth water-passing container:

The mineral-imparting material (B6) is mixture including: 60 weight % of lime stone; 30 weight % of fossil coral; and 10 weight % of shell.

In the mineral-containing water (B) producing apparatus 3 of the structure of FIG. 1, the mineral-containing water (B) has been obtained by make water pass through the first through the sixth water-passing containers which use the above-mentioned mineral-imparting material (B1)-(B6), respectively.

The respective mineral-imparting material (B1)-(B6) has the same weight of 50 kg (300 kg in total). And, the amount of the circulating water has been set up at 1000 kg, and the flow velocity thereof has been also set up at 500/40 mL/s.

The mineral-containing water (A) and the mineral-containing water (B) in Example 1 produced using the above-mentioned method have been mixed according to a weight ratio of 1:10 to obtain the mineral functional water in Example 1.

Utilizing a pH meter, which is a glass electrode type hydrogen-ion density indicator “TPX-90” manufactured by Toko Chemical Laboratories, pH of the mineral functional water in Example 1 has been measured to be a pH value of 11.5.

### (Evaluation of Spectral Emissivity)

An evaluation sample has been prepared by fixing the mineral functional water in Example 1 onto a ceramic carrier. And, the spectral emissivity of the sample has been measured with a far-infrared ray-radiating ratio-measuring apparatus (JIR-E500) manufactured by JEOL-Ltd.

The apparatus includes: a body of a Fourier transformed type infrared spectrophotometer (FTIR); a blackbody furnace; a sample-heating furnace; a temperature controller; and an attached optical system.

The evaluation sample with respect to spectral emissivity has been produced according to the following steps.

Based on 100 pts.wt. of ceramic powder (rock powder produced in Amakusa Ohyanoshima) for the carrier, 20 pts.wt. of the mineral functional water in Example 1 have been added to be clay.

The clay has been shaped into a flat disk having about 5 mm of thickness and 2 cm of diameter. And then, the shaped disk has been calcined at 1000 Centigrade to obtain the evaluation sample onto which mineral components contained in the sample (mineral functional water) have been fixed.

FIG. 12 shows the spectral radiation spectrum (measurement temperature: 25 Centigrade, wavelength: 4-24 micrometers) of the mineral functional water in Example 1 fixed onto the evaluation sample.

In addition, FIG. 12 also shows the spectral radiation spectrum (theoretical value) of the black body.

In FIG. 12, scales on the vertical axis indicate the strength of radiant energy using values (Watt) per square centimeters.

It means that the closer the measured curved line of the “evaluation sample” is to the theoretical curved line of the black body, the higher radiation power the evaluation sample possesses.

The vertical axis of FIG. 1 shows strength of radiation energy with watts per cm²

FIG. 13 shows the emissivity (wavelength: 4-24 micrometers) calculated according to the spectral radiation spectrum of the evaluation sample and the spectral radiation spectrum (theoretical value) of the black body.

### [2 Evaluation]

### Evaluation 1: Measurement of HP and Torque of Car

### Evaluation 1-1: Test Car 1 (Gearshift)

“Corolla (Trademark, gearshift)”, which is a 1500 cc class of passenger car, has been used as test car 1 and measurement has been made according to the followings at equipment for a chassis dynamometer driving test.

Test items have been HP and torque.

First, HP and torque of the test car 1 have been measured beforehand.

After that, 750 mL of the mineral functional water in Example 1 has been sprayed onto an engine and an engine room of the test car 1 to be coated thereon.

250 mL of the mineral functional water in Example 1 has been poured into a radiator of the test car 1.

Also after the coating has been dried, HP and torque of the test car 1 have been measured again according to a predetermined method with the chassis dynamometer.

Before applying the mineral functional water in Example 1, HP is 104.0, and torque is 15.7 Kgm.

After having applied the mineral functional water in Example 1, HP is 120.2, and torque is 20.2 Kgm.

As a result, it has been confirmed that 15% of HP and 29% of torque of the test car 1 have been increased thanks to applying the mineral functional water.

### Evaluation 1-2: Test Car 2 (Automatic Shift)

“Inspire (Trademark, automatic shift)”, which is a 3000 cc class of passenger car, has been used as test car 2 and measurement of HP and torque there of has been performed before and after applying the mineral functional water thereto to be compared with each other.

First, HP and torque of the test car 2 have been measured beforehand.

After that, 800 mL of the mineral functional water in Example 1 has been sprayed onto an engine and an engine room of the test car 2 to be coated thereon.

Also after the coating has been dried, HP and torque of the test car 2 have been measured again according to the predetermined method with the chassis dynamometer.

Before applying the mineral functional water in Example 1, HP is 179.5, and torque is 21.5 Kgm.

After having applied the mineral functional water in Example 1, HP is 194.5, and torque is 22.6 Kgm.

As a result, it has been confirmed that 8% of HP and 5% of torque of the test car 2 have been increased thanks to applying the mineral functional water.

### Evaluation 2: Exhaust Gas Evaluation

A commercial diesel car has been used as test car 3 and exhaust gas of the test car 3 before and after applying the mineral functional water thereto has been evaluated by means of an opacimeter (light transmission type smoke meter).

800 mL of the mineral functional water in Example 1 has been sprayed onto an engine and an engine room of the test car 3 to be coated thereon.

After that, having driven the test car 3 normally, evaluation values of the opacimeter have been recorded for three weeks after the coating.

Table 1 shows results thereof.

Measured values in Table 1 are average values of those obtained by performing measurement three times.

The words of “0 day” in Table 1 show data when the mineral functional water has not been coated yet.

TABLE 1

| After application (days) | Measured values (average) |
|---|---|
| 0 | 0.64 |
| 5 | 0.51 |
| 7 | 0.56 |
| 11 | 0.58 |
| 14 | 0.42 |
| 21 | 0.40 |

As shown in Table 1, after the coating of the mineral functional water, on the fifth day the value of the opacimeter decreases. After that, on the seventh day and the eleventh day, the value increases once. After the fourteenth day, the value decreases again.

On the twenty-first day, the value of exhaust gas decreases to reach 0.40.

In addition, after the above measurement, further measurement has been irregularly made for three months. In the further measurement, measurement values belong to a range from 0.4 to 0.45, and never increases up to before the coating.

It is supposed that the value increases once after the coating because unburnt carbon (soot) remains in the inside of the engine room and/or the exhaust system thereof.

It is also guessed that after that the value decreases again because the unburnt carbon is removed, thereby measuring values of exhaust gas after combustor efficiency has been improved.

As a result, it is confirmed that applying mineral functional water causes to obtain effects of reducing exhaust gas, the effects being maintained for a long period of time.

### Evaluation 3: Combustion-Promoting Test of Agricultural Boiler

The combustion-promoting tests have been performed by applying the mineral functional water in Example 1 to a commercial agricultural boiler.

First, a cover of a heat exchanging part of the boiler has been removed, and objects on the (cylindrical) surface of a heat exchanger have been washed out to be dried completely.

Next, 500 mL of the mineral functional water in Example 1 has been sprayed onto the whole heat exchanger and around a burner tip part to coat thereof.

The coating has been performed several times while waiting until the surface has gotten dried.

Commercial kerosene has been used as fuel to make the combustion boiler burn. Warm air from an outlet of the boiler has been supplied into a greenhouse in which tomatoes have been cultivated.

FIG. 14 shows results wherein temperature of the warm air discharged from the boiler is measured with time from immediately after operation of the boiler begins.

In a case where the coating with the mineral functional water is done, both a temperature rising rate and the maximum temperature from 5 minutes to 20 minutes after the beginning of the combustion are higher than those of another case where the coating is not done. This fact has been confirmed.

This fact reveals that spraying the mineral functional water in Example 1 onto the surface of the heat exchanging part and a burner of the boiler to generate an electric field reinforcing the combustion, thereby increasing both of flames and heat exchanging efficiency.

It is also confirmed that temperature measured at a position (distance: 7 m from the boiler, height: 1.2 m) on the average increases having a difference of 5 to 7 or more Centigrade from the original temperature.

Utilizing the mineral functional water-coated boiler, the tomatoes have been kept cultivated. As a result, oil consumption has been reduced at a ratio of 30% comparing with that of the same period in last year.

After the tomatoes have been harvested, similar tests have been performed onto the mineral functional water-coated boiler. As a result, the same increased temperature has been confirmed. In other words, it is recognized that the fuel-promoting action caused by the mineral functional water is maintained.

### INDUSTRIAL APPLICABILITY

The mineral functional water according to the present invention includes beneficial effects, such as improving action of combustion efficiency, and can be widely used in various industrial fields.

What is claimed is:

1. Mineral functional water, including mineral components of electromagnetic radioactivity and showing activating action on hydrocarbons.

2. The mineral functional water as defined in claim 1, further showing combustion-promoting action on hydrocarbons.

3. The mineral functional water as defined in claim 1, wherein the mineral components irradiate electromagnetic waves including wavelength resonating with mutual stretching vibration between C—H of molecules existing in the hydrocarbons.

4. Composition containing the mineral functional water as defined in claim 1.

5. A method of producing mineral functional water, comprising:
producing first mineral-containing water (A) according to the following first process (1): and
producing second mineral-containing water (B) according to the following second process (2):
the mineral functional water containing the first produced mineral-containing water (A) and the second produced mineral-containing water (B) according to a ratio within a range of 1:5-1:20 (weight ratio),
wherein the first process (1) includes:
immersing a conductive wire covered with insulator and mineral-imparting material (A) into water, the mineral-imparting material containing: woody plant raw material; vegetation raw material; and activated carbon, the vegetation raw material including: vegetation belonging to Asteraceae and vegetation belonging to Rosaceae, the woody plant raw material including at least one kind selected from a group consisting of Maple, Betula platyphylla, Pinus, and Cryptomeria japonica;
conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A), and
wherein the second process (2) uses six connected in series water-passing containers in which different kinds of inorganic mineral-imparting material (B) from each other is filled, the six water-passing containers including: a first water-passing container; a second water-passing container; a third water-passing container; a fourth water-passing container; a fifth water-passing container; and a sixth water-passing container,
wherein:
the mineral-imparting material (B1) filled into the first water-passing container is mixture including: 70 weight % of lime stone; 15 weight % of fossil coral; and 15 weight % of shell, respectively;
the mineral-imparting material (B2) filled into the second water-passing container is mixture including: 40 weight % of lime stone; 15 weight % of fossil coral; 40 weight % of shell; and 5 weight % of activated carbon, respectively;
the mineral-imparting material (B3) filled into the third water-passing container is mixture including: 80 weight % of lime stone; 15 weight % of fossil coral; and 5 weight % of shell, respectively;
the mineral-imparting material (B4) filled into the fourth water-passing container is mixture including: 90 weight % of lime stone; 5 weight % of fossil coral; and 5 weight % of shell, respectively;
the mineral-imparting material (B5) filled into the fifth water-passing container is mixture including: 80 weight % of lime stone; 10 weight % of fossil coral; and 10 weight % of shell, respectively; and
the mineral-imparting material (B6) filled into the sixth water-passing container is mixture including: 60 weight % of lime stone; 30 weight % of fossil coral; and 10 weight % of shell, respectively, and
making the water pass through the six water-passing containers to form mineral-containing water (B).

6. The method of producing mineral functional water as defined in claim 5, wherein:
10 to 15 weight % of the mineral-imparting material (A) based on the water is added; and the DC electric current conducted to the conductive wire has 0.05-0.1 A of a current value and 8000-8600 V of a voltage value, respectively.

7. The method of producing mineral functional water as defined in claim 5, wherein:
dried pulverized product of Asteraceae plants and dried pulverized product of Rosaceae plants are used as the mineral-imparting material (A);
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof) to produce third mixture; making the third mixture dry; and then pulverizing the dried third mixture; and
the activated carbon is composed of activated carbon powder (A3) produced by carbonizing coconut shell at activation temperature of 1000 Centigrade; and
the mineral-imparting material (A′) is obtained by;
mixing the vegetation raw material (A1) and the woody plant raw material (A2) according to 1:3 (weight ratio) to produce plant mixture; and
based on 100 pts. wt. of the plant mixture, mixing 2-8 weight % of the activated carbon powder (A3) thereto.

8. A method of combustion-promoting hydrocarbons, comprising:
directly or indirectly applying at least one of the mineral functional water defined in claim 1 and composition containing the mineral functional water.

9. Mineral functional water produced by a method comprising:
producing first mineral-containing water (A) according to the following first process (1): and
producing second mineral-containing water (B) according to the following second process (2):
the mineral functional water containing the first produced mineral-containing water (A) and the second produced mineral-containing water (B) according to a ratio within a range of 1:5-1:20 (weight ratio),
wherein the first process (1) includes:
immersing a conductive wire covered with insulator and mineral-imparting material (A) into water, the mineral-imparting material containing: woody plant raw material; and vegetation raw material; the vegetation raw material including: vegetation belonging to Asteraceae and vegetation belonging to Rosaceae, the woody plant raw material including at least one kind selected from a group consisting of Maple, Betula platyphylla, Pinus, and Cryptomeria japonica;
conducting DC electric current to the conductive wire to generate water flow around the conductive wire in the same direction as the DC electric current, applying ultrasonic vibration to the water, thereby forming raw mineral water solution (A); and
irradiating far-infrared rays (wavelength of 6-14 micrometers) to the raw mineral water solution (A) to form mineral-containing water (A), and
wherein 10 to 15 weight % of the mineral-imparting material (A) based on the water is added; and the DC electric current conducted to the conductive wire has 0.05-0.1 A of a current value and 8000-8600 V of a voltage value, respectively,
wherein:
dried pulverized product of Asteraceae plants and dried pulverized product of Rosaceae plants are used as the mineral-imparting material (A);
the dried pulverized product of the Asteraceae plants is produced by:
mixing 10 weight % of Cirsium japonicum (leaf parts, stem parts and flower parts thereof), 60 weight % of Artemisia indica (leaf parts and stem parts thereof) and 30 weight % of Farfugium japonicum (leaf parts and stem parts thereof), respectively to produce first mixture thereof; making the first mixture dry; and then pulverizing the dried first mixture;
the dried pulverized product of the Rosaceae plants is produced by:
mixing 20 weight % of Rosa multiflora (leaf parts and flower parts thereof), 10 weight % of Geum japonicum (leaf parts and stem parts thereof), and 70 weight % of Rubus L. (leaf parts, stem parts, and flower parts thereof), respectively to produce second mixture thereof; making the second mixture dry; and then pulverizing the dried second mixture;
the dried pulverized product of the Asteraceae plants and the dried pulverized product of the Rosaceae plants are mixed according to 1:1 (weight ratio) to obtain vegetation raw material (A1);
the woody plant raw material (A2) is produced by:
mixing 25 weight % of Maple (leaf parts and stem parts thereof), 25 weight % of Betula platyphylla (leaf parts, stem parts, and bark parts thereof), and 50 weight % of Cryptomeria japonica (leaf parts, stem parts, and bark parts thereof) to produce third mixture; making the third mixture dry; and then pulverizing the dried third mixture; and
activated carbon is composed of activated carbon powder (A3) produced by carbonizing coconut shell at activation temperature of 1000 Centigrade; and
the mineral-imparting material (A′) is obtained by;
mixing the vegetation raw material (A1) and the woody plant raw material (A2) according to 1:3 (weight ratio) to produce plant mixture; and
based on 100 pts. wt. of the plant mixture, mixing 2-8 weight % of the activated carbon powder (A3) thereto,
wherein the second process (2) uses six connected in series water-passing containers in which different kinds of inorganic mineral-imparting material (B) from each other is filled, the six water-passing containers including: a first water-passing container; a second water-passing container; a third water-passing container; a fourth water-passing container, a fifth water-passing container; and a sixth water-passing container,
wherein:
the mineral-imparting material (B1) filled into the first water-passing container is mixture including: 70 weight % of lime stone; 15 weight % of fossil coral; and 15 weight % of shell, respectively;
the mineral-imparting material (B2) filled into the second water-passing container is mixture including: 40 weight % of lime stone; 15 weight % of fossil coral; 40 weight % of shell; and 5 weight % of activated carbon, respectively;
the mineral-imparting material (B3) filled into the third water-passing container is mixture including: 80 weight % of lime stone; 15 weight % of fossil coral; and 5 weight % of shell, respectively;
the mineral-imparting material (B4) filled into the fourth water-passing container is mixture including: 90 weight % of lime stone; 5 weight % of fossil coral; and 5 weight % of shell, respectively;
the mineral-imparting material (B5) filled into the fifth water-passing container is mixture including: 80 weight % of lime stone; 10 weight % of fossil coral; and 10 weight % of shell, respectively; and
the mineral-imparting material (B6) filled into the sixth water-passing container is mixture including: 60 weight % of lime stone; 30 weight % of fossil coral; and 10 weight % of shell, respectively, and
making the water pass through the six water-passing containers to form mineral-containing water (B).

10. The mineral functional water as defined in claim 9, wherein the first produced mineral-containing water (A) and the second produced mineral-containing water (B) are mixed according to a ratio within a range of 1:10 (weight ratio).

11. The Mineral functional water as defined in claim 9, further including mineral components of electromagnetic radioactivity and showing activating action on hydrocarbons.

12. The mineral functional water as defined in claim 11, further showing combustion-promoting action on hydrocarbons.

13. The mineral functional water as defined in claim 11, wherein the mineral components irradiate electromagnetic waves including wavelength resonating with mutual stretching vibration between C—H of molecules existing in the hydrocarbons.

14. Composition containing the mineral functional water as defined in claim 9.

15. A combustion-promoting method, comprising:
directly or indirectly applying at least one of the mineral functional water as defined in claim 9 and the composition containing the mineral functional water to fuel containing hydrocarbons.
